(19) United States
(12) Patent Application Publication
(10) Pub. No.: US 2025/0292573 A1
(43) Pub. Date: Sep. 18, 2025

(54) SEGMENTING DIGITAL VIDEOS UTILIZING TRANSCRIPT CHAPTERIZATION AND VISUAL BREAKS

(71) Applicant: Dropbox, Inc., San Francisco, CA (US)

(72) Inventors: Alan Rogers, Brunswick (AU); Thomas Berg, San Francisco, CA (US); Tristan Inghelbrecht, East Richmond Heights, CA (US)

(21) Appl. No.: 18/602,881

(22) Filed: Mar. 12, 2024

(51) Int. Cl. G06V 20/40; G06T 7/90; G06V 10/44; G10L 15/18; H04N 19/172

(52) U.S. Cl. CPC G06V 20/49; G06T 7/90; G06V 10/44; G10L 15/1815; H04N 19/172; G06V 2201/07

(57) ABSTRACT

The present disclosure relates to systems, methods, and non-transitory computer-readable media for segmenting a digital video to segment a digital video by employing a chapterization approach to video transcripts based on contextual data from audio signals and video signals together. In some embodiments, the disclosed systems can extract various types of audio signals and various types of video signals from a digital video. From the extracted signals, the disclosed systems can determine a set of break points to segment a video transcript. In some embodiments, the disclosed systems can further recommend, via a notification on a client device, inserting corresponding breaks from the segmented transcript into the digital video.

### BACKGROUND

In recent years, there have been significant improvements in digital video transcription technology and digital video segmentation technology. For instance, conventional digital video systems can translate audio within a digital video into written text. Such systems can also provide for the written text of the digital video to be displayed on, and read from, a graphical user interface. Further, some conventional digital video systems can analyze content of a digital video to detect different scenes within the digital video.

Despite such benefits, conventional systems have a number of problems relating to their accuracy and flexibility. As an example, many conventional digital video systems generate inaccurate transcripts from digital videos by employing rudimentary transcription algorithms that rely solely on audio data when converting digital video data into written text. Indeed, by rigidly fixing the analysis on audio data alone, existing systems often produce transcripts that include continuous streams of words, perhaps broken up by speaker with little or no additional context. Such unending streams of text are often illegible and inaccurate, misplacing break points of a transcript or bypassing a break point altogether.

These along with additional problems and issues exist with regard to conventional digital video transcription systems and digital video segmentation systems.

### SUMMARY

This disclosure describes one or more embodiments of systems, methods, and non-transitory computer readable storage media that provide benefits and/or solve one or more of the foregoing and other problems in the art. For instance, the disclosed systems can segment a digital video by employing a chapterization approach to video transcripts based on contextual data from audio signals and video signals together. In some embodiments, the disclosed systems can extract various types of audio signals and various types of video signals from a digital video. From the extracted signals, the disclosed systems can determine a set of break points to segment a video transcript. In some embodiments, the disclosed systems can further recommend, via a notification on a client device, inserting corresponding breaks from the segmented transcript into the digital video. Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an example environment in which a video transcript segmentation system can operate in accordance with one or more embodiments.

FIG. 2 illustrates an example overview of generating and visualizing a segmented video transcript of a digital video and a video break notification in accordance with one or more embodiments.

FIG. 3 illustrates an example diagram for extracting audio features from a digital video in accordance with one or more embodiments.

FIG. 4 illustrates an example diagram for extracting video features from a digital video in accordance with one or more embodiments.

FIG. 5 illustrates an example diagram for generating a segmented video transcript by utilizing confidence scores in accordance with one or more embodiments.

FIG. 6 illustrates an example diagram for generating a potential break point in accordance with one or more embodiments.

FIG. 7 illustrates an example diagram for combining and visualizing separated transcript sections of a digital video and a video break notification in accordance with one or more embodiments.

FIG. 8 illustrates an example user interface for providing a video break notification suggesting timestamps of a digital video for inserting breaks in accordance with one or more embodiments.

FIG. 9 illustrates an example graphical user interface for providing inserted breaks at timestamps of a digital video in accordance with one or more embodiments.

FIG. 10 illustrates an example flowchart of a series of acts for generating and visualizing a segmented video transcript of a digital video and a video break notification in accordance with one or more embodiments.

FIG. 11 illustrates a block diagram of an exemplary computing device in accordance with one or more embodiments.

FIG. 12 illustrates an example environment of a networking system including the video transcript segmenting system in accordance with one or more embodiments.

### DETAILED DESCRIPTION

This disclosure describes one or more embodiments of a video transcript segmentation system that can generate a segmented video transcript jointly based on audio signals and video signals of a digital video. To generate a segmented video transcript, the video transcript segmentation system can extract audio signals that indicate potential audio-based break points in a transcript as well as video signals that indicate potential video-based break points. The video transcript segmentation system can also utilize a break point prediction model (e.g., a heuristic model or a machine learning model) to determine a final set of break points by reconciling or aligning the potential break points from the audio signals and the video signals to determine timestamps where actual break points should be placed in a transcript. In some embodiments, the video transcript segmentation system thus generates a segmented video transcript to use as a basis for suggesting or inserting break points into the digital video itself.

As just mentioned, the video transcript segmentation system can extract different types of audio signals and different types of video signals from the digital video. For example, the video transcript segmentation system can extract audio signals that are indicative of topic changes, sentence breaks, or the starting and stopping of speech in the digital video (and/or its corresponding transcript). As another example, the video transcript segmentation system can extract video signals that correspond to the visual makeup of a frame (or scene) in the digital video, a change or transition in the video content of the digital video, or changes corresponding to an object depicted in the digital video.

Based on extracting the audio signals and the video signals, the video transcript segmentation system can, as noted above, utilize the signals to determine a set of break points for segmenting a digital video transcript (and/or the corresponding digital video). For instance, in some embodiments, the video transcript segmentation system can utilize a break point prediction model to generate the set of break points based on the audio signals and/or video signals. In one or more embodiments, the break point prediction model generates the set of break points by generating confidence scores for potential break points based on the audio signals and video signals of the digital video, combining the confidence scores into an overall confidence score (or a break point score), and comparing the overall confidence score with a given threshold for designating a break point at a particular timestamp.

As also indicated above, the video transcript segmentation system can provide a suggestion to insert break points into a digital video. For example, the video transcript segmentation system uses the segmented video transcript as a rubric for segmenting the corresponding digital video. Indeed, the video transcript segmentation system can provide suggestions for inserting (or can automatically insert) segments in a digital video at timestamps aligning with break points generated for the segmented video transcript.

Through one or more of the embodiments mentioned above (and described in further detail below), the video transcript segmentation system can provide several improvements or advantages over existing digital video systems. For example, the video transcript segmentation system can improve flexibility over prior systems. Indeed, while prior systems employ rudimentary transcription algorithms that rely solely on audio data when converting digital video data into written text, the video transcript segmentation system can, in one or more embodiments, predict break points based on a combination of both audio data and video data. Specifically, the video transcript segmentation system can extract audio features (e.g., topic changes, sentence breaks, and speech start and stop) and video features (e.g., a visual makeup of a frame in the video content or a threshold change in composition of the video content between frames) of a digital video to, in some embodiments, compare (timing for) the audio signals to the video signals. Based on this comparison, the video transcript segmentation system can determine a set of break points to segment the video transcript. Because the video transcript segmentation system is not confined solely to audio data, it is able to more readily adapt to the different types of features (e.g., audio features and video features) present in a digital video. Thus, the video transcript segmentation system can flexibly consider and respond to much more context in a digital video than prior systems are able to.

Due at least in part to its flexibility, the video transcript segmentation system also exhibits improved accuracy over existing systems. For instance, in contrast to existing systems that (as a result of relying solely on audio data) produce transcripts with continuous, unbroken streams of text (that are often illegible and inaccurate), the video transcript segmentation system can produce a video transcript with accurate segmentations or breaks. In particular, by jointly utilizing audio and video data in the generative and comparative process as just described above (and below in greater detail), the video transcript segmentation system can more precisely determine where breaks in a video transcript (and a corresponding digital video) should most appropriately occur. Indeed, by extracting and comparing audio and video data, the video transcript segmentation system can much more accurately analyze the context of scenes in the digital video and generate corresponding segmented video transcripts than existing systems are able to do. Consequently, the video transcript segmentation system can make video transcripts more logistically editable than existing systems are able to.

As illustrated by the foregoing discussion, the present disclosure utilizes a variety of terms to describe features and advantages of the video transcript segmentation system. Additional detail is now provided regarding the meaning of such terms. As used herein, the term “audio feature” (or “audio signal”) refers to computer code that a computer processor can generate and/or analyze to denote and define specific attributes, characteristics, and/or changes in audio data (or audio content) throughout a digital video. In particular, the term audio feature can include a segment of code (e.g., a vector) extracted or encoded from audio content in the digital video that is recognized by a computer processor as a delimiter indicating a particular point of change or a transition within audio data. Based on this delimited segment of code, the computer processor can identify a particular timestamp in the digital video wherein a potential break point can be inserted. To illustrate, an audio feature can include a segment of code that indicates a topic change or a sentence break in the audio content of the digital video. An audio feature can also include a segment of code that indicates when speech starts in the audio content or when speech stops in the audio content.

As used herein, the term “video feature” (or “video signal”) refers to computer code that a computer processor can generate and/or analyze to denote and define specific attributes, characteristics, and/or changes in video data (or video content) throughout a digital video. In particular, the term video feature can include a segment of code (e.g., a vector) corresponding to video content in the digital video that is recognized by a computer processor as a delimiter indicating a particular point of change or a transition within video data. Based on this delimited segment of code, the computer processor can identify a particular timestamp in the digital video wherein a potential break point can be inserted. As an example, a video feature can include a segment of code that indicates a visual makeup of a frame in the video content of a digital video (e.g., a color analysis of the pixels in the frame) or a threshold change in composition of the video content between frames of the digital video (e.g., a change corresponding to an object depicted in a frame when compared to another frame).

On these lines, the term “feature extractor” refers to a computer code that a processor can utilize to extract and analyze specific forms of data (or content) from a digital video. Specifically, a feature extractor can include a segment of code (e.g., a vector) that identifies and extracts specific attributes or characteristics from audio content and/or video content of a digital video. Moreover, a feature extractor can analyze extracted attributes or characteristics from the audio content and/or video content to determine which attributes or characteristics can be utilized for given purpose. For example, the video transcript segmentation system can utilize an audio feature extractor to extract and analyze audio features from a digital video. As another example, the video transcript segmentation system can further utilize a video feature extractor to extract and analyze video features from a digital video.

As used herein, the term “break point” refers to a particular moment or marker in a video transcript where the video transcript can be divided into separate segments. For instance, in some embodiments, the video transcript segmentation system can determine a timestamp to insert break points by extracting audio features and video features of a digital video, generating individual confidence scores for both the audio features and the video features, combining the separate confidence scores into an overall confidence score (or a break point score), and comparing the overall confidence score with a given threshold for designating a break point at a particular timestamp. In some embodiments, the video transcript segmentation system can utilize models, such as a break point prediction model, to determine a set of break points. Relatedly, as used herein, the term “video break” refers to an actual break or transition within a digital video caused by inserting a break point.

Relatedly, as used herein, the term “break point score” refers to a score indicating a likelihood, a confidence, or a probability of a break point occurring at a particular timestamp within a video transcript or a digital video. In some cases, a break point score takes the form of an overall confidence score resulting from a combination of two or more confidence scores. For instance, the video transcript segmentation system 102 can generate the break point score by combining a first confidence score (e.g., based on extracted audio features of a digital video) with a second confidence score (e.g., based on extracted video features of the digital video). The video transcript segmentation system 102 generates break point scores to, for example, provide a more accurate potential break point and set of break points than would otherwise be possible by relying solely upon a single confidence score (e.g., a confidence score based solely upon an audio feature or a confidence score based solely upon a video feature).

Along these lines, as used herein, the term “segmented video transcript” refers to a digital video transcript that has been, based on a set of determined break points, divided into segments. In particular, the video transcript segmentation system can, in one or more embodiments, divide a digital video transcript into smaller, discrete parts and/or organize the transcript into sections that relate to a common topic. For instance, the video transcript segmentation system can create a segmented video transcript by breaking up a stream of text into separate paragraphs, sections, or chapters.

As indicated above, the video transcript segmentation system can determine a set of break points using models, such as a break point prediction model. As used herein, the term “break point prediction model” refers to a model, such as a heuristic model or a machine learning model, that determines a set of break points by utilizing audio features and video features of a digital video. For instance, the break point prediction model can, in some embodiments, utilize audio and video features of a digital video to generate a potential break point and combine the potential break point with one or more other potential break points to determine a set of break points.

Relatedly, as used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. In some embodiments, the video transcript segmentation system utilizes a large language machine learning model in the form of a neural network.

As used herein, the term “large language model” refers to a set of one or more machine learning models (e.g., neural networks) trained to perform computer tasks to generate or identify computing code and/or data in response to trigger events (e.g., user interactions, such as text queries and button selections). In particular, a large language model can be a neural network (e.g., a deep neural network) with many parameters trained on large quantities of data (e.g., unlabeled text) using a particular learning technique (e.g., self-supervised learning). For example, a large language model can include (hundreds of millions or billions of) parameters trained to generate an output, such as text, images, computer code, and/or other data based on an input prompt that defines instructions for output generation along with contextual data. Example large language models include ChatGPT (and its iterations), META's Llama, or GOOGLE's Lambda.

Along these lines, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., a set of break points) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, a diffusion neural network, a large language model, or a generative adversarial neural network.

As used herein, the term “video frame embedding” refers to a latent numerical representation of digital content portrayed in a frame of a digital video. In particular, a video frame embedding can be a latent numerical representation (e.g., a latent vector) of digital content portrayed in a frame of a digital video transformed or converted into a format that a system (e.g., the video transcript segmentation system) can understand and process. As an example, the video transcript segmentation system can transform a latent numerical representation by converting the raw pixel data of a given frame in a digital video into a vector (or an arrangement of numbers) that captures visual features (e.g., colors, patterns, shapes, textures) of the given frame.

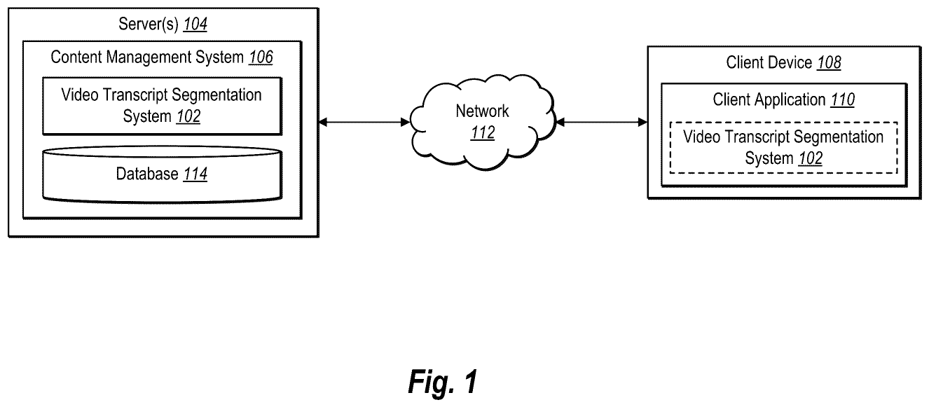

Additional detail regarding the video transcript segmentation system will now be provided with reference to the figures. For example, FIG. 1 illustrates a schematic diagram of an example system environment for implementing a video transcript segmentation system 102 in accordance with one or more implementations. An overview of the video transcript segmentation system 102 is described in relation to FIG. 1. Thereafter, a more detailed description of the components and processes of the video transcript segmentation system 102 is provided in relation to the subsequent figures.

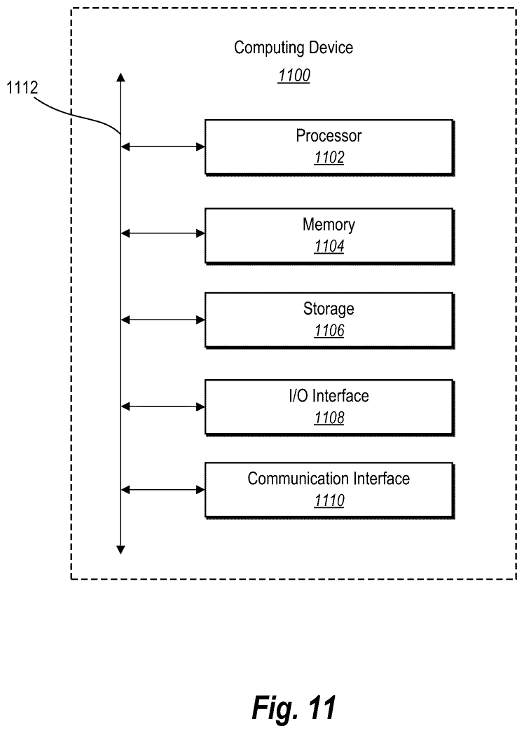

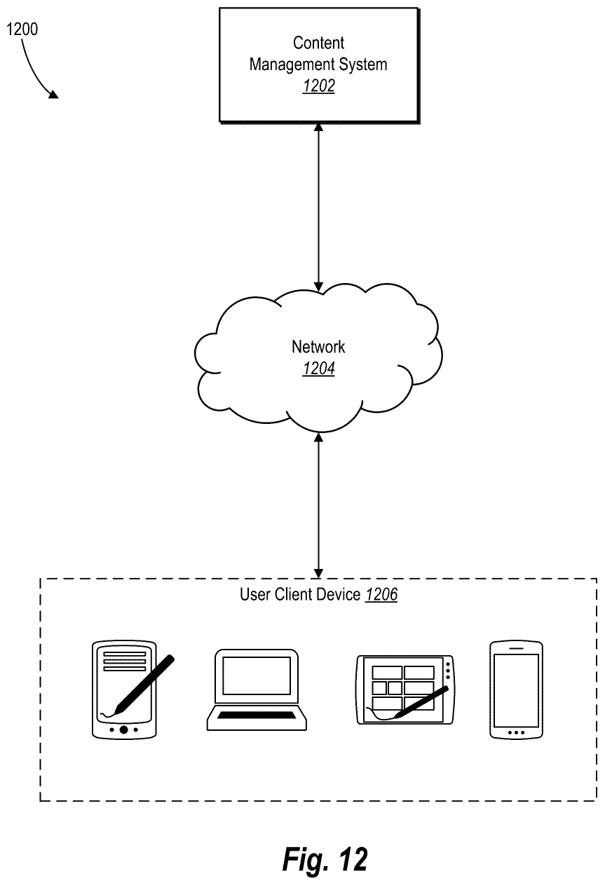

As shown, the environment includes server(s) 104, client device 108, and a network 112. Each of the components of the environment can communicate via the network 112, and the network 112 may be any suitable network over which computing devices can communicate. Example networks are discussed in more detail below in relation to FIGS. 11-12.

As mentioned above, the example environment includes a client device 108. The client device 108 can be one of a variety of computing devices, including a smartphone, a tablet, a smart television, a desktop computer, a laptop computer, a virtual reality device, an augmented reality device, or another computing device as described in relation to FIGS. 11-12. The client device 108 can communicate with the server(s) 104 via the network 112. For example, the client device 108 can receive user input from a user interacting with the client device 108 (e.g., via the client application 110) to, for instance, access, generate, modify, or share a content item, to collaborate with a co-user of a different client device, or to select a graphical user interface element. In addition, the video transcript segmentation system 102 on the server(s) 104 can receive information relating to various interactions with content items and/or graphical user interface elements based on the input received by the client device 108 (e.g., to generate a segmented transcript or a segmented digital video).

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including a transcript segmentation interface for digitally presenting and/or applying a suggested set of break points for a digital video.

As illustrated in FIG. 1, the example environment also includes the server(s) 104. The server(s) 104 may generate, track, store, process, receive, and transmit electronic data, such as digital content items, audio signals, video signals, confidence scores, interface elements, interactions with digital content items, interactions with interface elements, and/or interactions between user accounts or client devices. For example, the server(s) 104 may receive data from the client device 108 in the form of user interactions with interface elements and/or digital video data for extracting audio signals and video signals. In addition, the server(s) 104 can transmit data to the client device 108 in the form of a transcript segmentation interface that includes a digital visualization of suggested break points for a digital video. Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning server, and other types of servers.

As shown in FIG. 1, the server(s) 104 can also include the video transcript segmentation system 102 as part of a content management system 106. The content management system 106 can communicate with the client device 108 to perform various functions associated with the client application 110 such as managing user accounts, managing content collections, managing content items, and facilitating user interaction with the content collections and/or content items. Indeed, the content management system 106 can include a network-based smart cloud storage system to manage, store, and maintain content items and related data across numerous user accounts, including user accounts in collaboration with one another. In some embodiments, the video transcript segmentation system 102 and/or the content management system 106 utilize a database 114 to store and access information such as digital content items, audio signals, video signals, segmented video transcripts, and user account behavior data.

Although FIG. 1 depicts the video transcript segmentation system 102 located on the server(s) 104, in some implementations, the video transcript segmentation system 102 may be implemented by (e.g., located entirely or in part on) one or more other components of the environment. For example, the video transcript segmentation system 102 may be implemented by the client device 108 and/or a third-party device. For example, the client device 108 can download all or part of the video transcript segmentation system 102 for implementation independent of, or together with, the server(s) 104.

In some implementations, though not illustrated in FIG. 1, the environment may have a different arrangement of components and/or may have a different number or set of components altogether. For example, the client device 108 may communicate directly with the video transcript segmentation system 102, bypassing the network 112. As another example, the environment can include the database 114 located external to the server(s) 104 (e.g., in communication via the network 112) or located on the server(s) 104, on a third-party system, and/or on the client device 108. As yet another example, the environment can include a third-party server hosting a large language model in communication with the video transcript segmentation system 102 for generating predicted break points according to guidance parameters from audio and/or video signals.

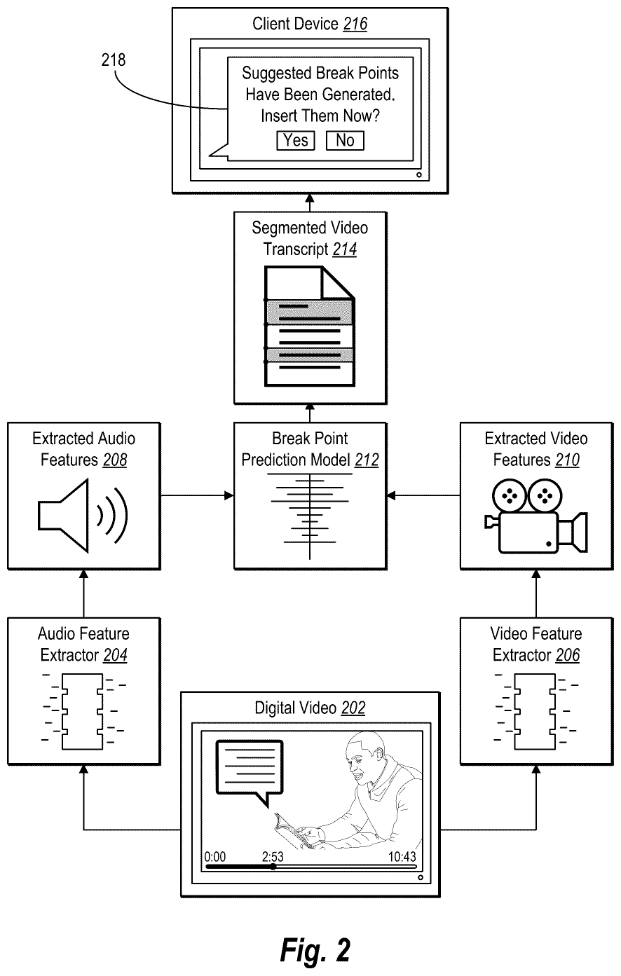

As mentioned above, the video transcript segmentation system 102 can generate and provide digital visualizations for a suggested set of break points for a digital video. In particular, video transcript segmentation system 102 can generate suggested break points for a video transcript from audio features and video features of a digital video. FIG. 2 illustrates an example overview of generating the suggested set of break points in accordance with one or more embodiments. Additional detail regarding the various acts and processes introduced in relation to FIG. 2 is provided thereafter with reference to subsequent figures.

As illustrated in FIG. 2, the video transcript segmentation system 102 identifies or receives a digital video 202. For example, the video transcript segmentation system 102 receives the digital video 202 as an upload from a client device or a selection from a network-based location (e.g., a cloud storage location) associated with a user account of the content management system 106. As shown, the digital video 202 includes ten minutes and forty-three seconds of digital content, including audio content and video content (e.g., as separable data streams).

As also illustrated in FIG. 2, the video transcript segmentation system 102 can generate extracted audio features 208 from the digital video 202. More specifically, the video transcript segmentation system 102 can extract audio features by utilizing an audio feature extractor 204. For example, the video transcript segmentation system 102 utilizes the audio feature extractor 204 to extract audio features indicating a topic change, a sentence break, or a start or a stop to speech in the audio content of the digital video 202.

As further illustrated in FIG. 2, the video transcript segmentation system 102 can generate extracted video features 210 from the digital video 202. Particularly, the video transcript segmentation system 102 can extract video features by utilizing a video feature extractor 206. For example, the video transcript segmentation system utilizes the video feature extractor 206 to extract video features indicating a visual makeup of a frame in the video content of the digital video 202 (e.g., a color analysis of the pixels in the frame) or a threshold change in composition of the video content between frames of the digital video 202 (e.g., a change corresponding to an object depicted in one frame when compared to another frame).

In one or more embodiments, the video transcript segmentation system 102 utilizes a break point prediction model 212 to determine potential break points for the digital video 202. To elaborate, the break point prediction model 212 processes the extracted audio features 208 and the extracted video features 210 to generate predictions of timestamps for break points. In some cases, the video transcript segmentation system 102 extracts, generates, or accesses a transcript for the digital video 202 to use as a basis for predicting break points. The video transcript segmentation system 102 thus utilizes the break point prediction model 212 to generate predicted break points within the transcript based on the extracted audio features 208 and the extracted video features 210.

Additionally, the video transcript segmentation system 102 further utilizes the break point prediction model 212 to generate a segmented video transcript 214. Specifically, the break point prediction model 212 generates a first confidence score based on the extracted audio features 208 and second confidence score based on the extracted video features 210. In some instances, the break point prediction model 212 combines the two confidence scores together to generate a potential break point. Using one or more potential break points, the break point prediction model 212 can further determine a set of break points for generating the segmented video transcript 214. In some embodiments, the video transcript segmentation system 102 generates a rearranged segmented video transcript by rearranging sections in the transcript to, for example, combine sections that deal with related or common topic matter.

As FIG. 2 illustrates, the video transcript segmentation system 102 also generates a video break notification 218 for display on a graphical user interface of a client device 216. In particular, the video transcript segmentation system 102 processes the segmented video transcript 214 to generate the video break notification 218. For example, the video break notification 218 can suggest inserting a set of break points (determined from the segmented video transcript 214) into digital video 202. To suggest inserting the set of break points, the video transcript segmentation system 102 can display the video break notification 218 on the graphical user interface of the client device 216. In at least one embodiment, the video transcript segmentation system 102 generates, for display on the graphical user interface of the client device 216, the video break notification 218 with one or more selectable elements that provides an option for whether or not to insert the set of break points into the digital video 202.

In some embodiments, the video transcript segmentation system 102 automatically (e.g., without interaction prompting) generates a segmented digital video for display on a client device (e.g., without first providing a notification). Indeed, the video transcript segmentation system 102 can generate a video break for each predicted break point within a video transcript. For instance, the video transcript segmentation system 102 generates a video break as a transition or break between frames of a digital video based on generating the segmented video transcript 214. In some cases, the video transcript segmentation system 102 generates a video break by inserting one or more blank (e.g., white or black) frames into a digital video. In these or other cases, the video transcript segmentation system 102 generates a video break by inserting a flag or other indicator of a break point (including a description of the video break or the break point, such as audio and/or video features that led to the video break).

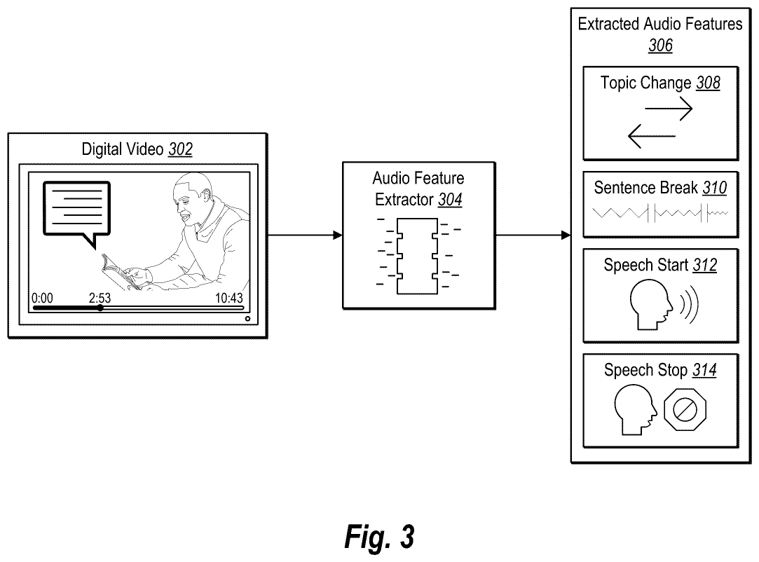

As expressed above, in certain described embodiments, the video transcript segmentation system 102 generates a set of break points based in part on extracted audio features of a digital video. In particular, the video transcript segmentation system 102 utilizes an audio feature extractor to extract audio features (or set of audio features) from the digital video. FIG. 3 illustrates an example diagram for extracting audio features (or set of audio features) from the digital video in accordance with one or more embodiments.

As also illustrated in FIG. 3, the video transcript segmentation system 102 utilizes an audio feature extractor 304 to extract audio features (e.g., a set of audio features) from the digital video 302. Specifically, the audio feature extractor 304 can identify and extract audio features from a video transcript of the digital video 302. For example, the video transcript segmentation system 102 extracts or generates a video transcript from an audio channel of the digital video 302 and further analyzes the video transcript to determine audio signals or audio features. Indeed, the video transcript segmentation system 102 can analyze the text of the video transcript utilizing an audio feature extractor 304. Through such analysis, the video transcript segmentation system 102 can generate extracted audio features 306.

Indeed, by analyzing a video transcript (and/or audio data), the video transcript segmentation system 102 can identify or define specific attributes, characteristics, and/or changes in audio content throughout the digital video 302. To illustrate, in one or more embodiments, the audio feature extractor 304 analyzes a video transcript (or code or data extracted from an audio channel) to denote delimiters indicating a particular point of change or transition in the data. For instance, the audio feature extractor 304 determines a timestamp where a speaker begins or ends speaking. As another example, the audio feature extractor 304 determines a timestamp where audio content changes in volume by at least a threshold amount and/or where audio content changes from one song/track to another (e.g., another of a different type contrasting with a previous type).

Upon identifying the audio features, the audio feature extractor 304 can extract the audio features (or set of audio features) from the digital video 302. In some instances, the audio feature extractor 304 utilizes a text-based model to extract sentence embeddings (e.g., a vector representation of a sentence extracted from the digital video 302 which captures semantic information about the sentence) from a video transcript or subtitle track of the digital video 302. In one or more embodiments, the audio feature extractor 304 analyzes the extracted sentence embeddings to detect and extract the audio features (or set of audio features). For example, the audio feature extractor 304 analyzes text-based audio data to identify particular words or phrases that indicate potential break points, such as transitional phrases (e.g., “Here is a clip of what we did last week” or “Welcome back”) that indicate a change in depicted audio content. Indeed, the audio feature extractor 304 can extract audio features directly from audio data and/or from text-based data converted from audio data.

As just mentioned, and as further illustrated in FIG. 3, the video transcript segmentation system 102 utilizes the audio feature extractor 304 to generate extracted audio features 306 from digital video 302. For instance, the video transcript segmentation system 102 utilizes the audio feature extractor 304 (e.g., a semantic topic model) to extract audio features (from audio-based data and text-based data) indicating a topic change 308 in the audio content of the digital video 302. To illustrate, the audio features indicate a topic change 308 where the audio feature extractor 304 identifies (such as by utilizing topic modeling, keyword and phrase analysis, and/or semantic analysis) a shift (gradual or abrupt) in focus of a conversation or discussion from one subject to another subject.

In one or more embodiments, the video transcript segmentation system 102 further utilizes the audio feature extractor 304 to extract audio features in the audio content of the digital video 302 indicating a sentence break 310, speech start 312, and/or speech stop 314. For example, the audio features indicate a sentence break 310 where the audio feature extractor 304 denotes (such as by utilizing automatic speech recognition, punctuation prediction, and/or speaker diarization) the point(s) at which one sentence ends and another begins. As another example, the audio features indicate speech start 312 and speech stop 314 where the audio feature extractor 304 identifies a point in the audio content where a given segment of speech in the digital video originates and where the given segment of speech in the digital video terminates, respectively.

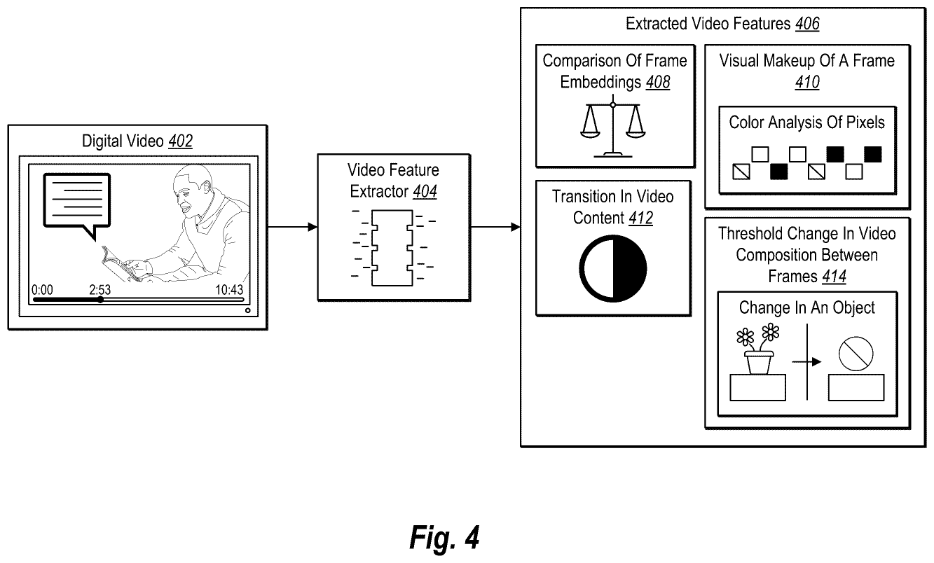

As expressed above, in specific described embodiments, the video transcript segmentation system 102 generates a set of break points based in part on extracted video features of a digital video. In particular, the video transcript segmentation system 102 utilizes a video feature extractor to extract video features (or set of video features) from the digital video. FIG. 4 illustrates an example diagram for extracting video features (or set of video features) from the digital video in accordance with one or more embodiments.

As illustrated in FIG. 4, the video transcript segmentation system 102 utilizes a video feature extractor 404 to extract video features (or set of video features) from the digital video 402. Specifically, the video feature extractor 404 can identify video features by analyzing and defining specific attributes, characteristics, and/or changes in video content throughout the digital video 402. To illustrate, in one or more embodiments, the video feature extractor 404 analyzes code from the video content of the digital video 402 to denote delimiters indicating a particular point of change or transition in the data. Upon identifying the video features, the video feature extractor 404 can extract the video features (or set of video features) from the digital video 402. In some cases, the video feature extractor 404 utilizes a video codec (e.g., FFmpeg) or another computer program to identify and extract the video features (or set of video features).

As further illustrated in FIG. 4, in some embodiments, the video transcript segmentation system 102 utilizes the video feature extractor 404 to generate extracted video features 406 from digital video 402. For instance, the video transcript segmentation system 102 utilizes the video feature extractor 404 to extract video features corresponding to a visual makeup of a frame 410 in the video content of a digital video 402. For instance, the video feature extractor 404 identifies and extracts video features corresponding to the visual makeup of a frame 410 by analyzing and converting raw pixel data from a frame in the digital video 402 into a vector that captures or encodes one or more visual features of the frame. Such visual features of the frame can include, for example, color of pixels (e.g., based on performing a color analysis of the pixels in the frame), specific patterns, specific shapes, and/or specific textures in the frame. In some embodiments, the video transcript segmentation system 102 utilizes the visual makeup of frames as the basis for determining or extracting other video features by, for example, comparing the visual makeups of consecutive frames to determine transition points in the digital video 402.

In one or more embodiments, the video transcript segmentation system 102 also utilizes the video feature extractor 404 to generate extracted video features 406 corresponding to a comparison of frame embeddings 408 from the video content of the digital video 402. To illustrate, the video feature extractor 404 analyzes and extracts a first video frame embedding encoding the video content of a specific frame in the digital video 402, analyzes and extracts a second video frame embedding encoding the video content of another specific frame (e.g., a next consecutive frame) in the digital video 402, and compares the first video frame embedding to the second video frame embedding to determine a differences and/or a change in the encoded video content between the frames. As an example, the video feature extractor 404 can compare frames of a digital video 402 to detect when an individual enters or exits a frame. In some instances, the video feature extractor 404 extracts and compares each frame of the digital video 402 and/or compares a subset of video frames (e.g., a frame every second) to detect a difference or a change in the encoded video content between the frames.

Relatedly, in some cases, the video transcript segmentation system 102 utilizes the video feature extractor 404 to generate extracted video features 406 corresponding to a transition in video content 412. Specifically, by analyzing, extracting, and comparing frames in a manner similar to the method described above in relation to a comparison of frame embeddings 408, the video feature extractor 404 can detect transitions in the video content of the digital video 402. To list some examples, the video feature extractor 404 can compare frames of a digital video 402 to detect a video stream: transitioning from a forest scene to a city scene, transitioning from all color to black and white, cutting away to a black frame, or switching to a new camera angle (or a new camera). In some cases, the video feature extractor 404 utilizes a filtering technique (e.g., a bilateral filtering technique) to detect more subtle (or less drastic) transitions (e.g., fade transitions) between frames in the digital video 402 and to extract the video features.

Along these lines, as further illustrated in FIG. 4, the video transcript segmentation system 102 further utilizes the video feature extractor 404 to generate extracted video features 406 corresponding a threshold change in video composition between frames 414 of the digital video 402. Specifically, by analyzing, extracting, and comparing frames in a manner similar to the method described above in relation to a comparison of frame embeddings 408 and a transition in video content 412, the video feature extractor 404 can denote threshold changes in the composition of one frame compared to another frame. For instance, the video feature extractor 404 can detect a change in an object depicted in the digital video 402, including the presence (or introduction) of a new object within a frame of the digital video 402 or an absence (or removal) of a previously depicted object in a frame of the digital video 402. To illustrate, the threshold change in video composition between frames 414 can include, for example, introducing a pot of flowers into a scene or, as shown, removing a pot of flowers from a scene. In some cases, the video transcript segmentation system 102 determines a threshold composition change based on a threshold number of pixels changing (at least a threshold amount) between compared frames.

In the same or other embodiments, the video transcript segmentation system 102 further utilizes the video feature extractor 404 to generate extracted video features 406 by generating and comparing text descriptions of depicted video content. Specifically, the video feature extractor 404 can, in some instances, utilize image captioning (e.g., dense captioning) to capture frames (or images) in the digital video 402 and generate a text description (e.g., a caption) for each captured frame. In the same or other embodiments, the video feature extractor 404 can break up the digital video 402 into segments. For instance, the video feature extractor 404 can break up the video into segments (e.g., 10 seconds) and generate a text description (or summary) of the video content in each segment. In one or more embodiments, the video feature extractor 404 can compare the text descriptions of the captured frames (or segments) to denote and define specific changes in the video content of the digital video 402.

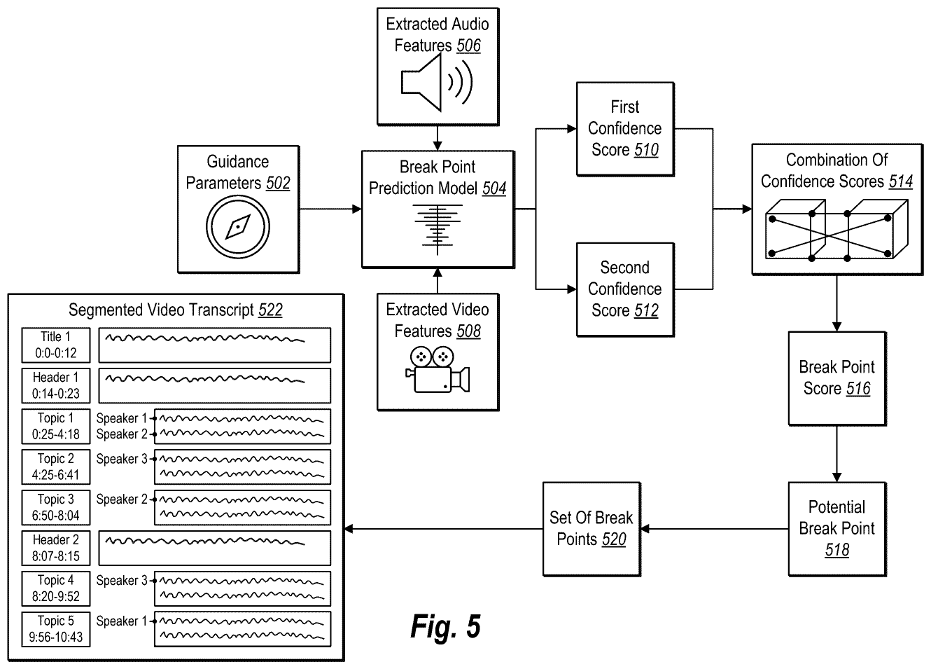

As mentioned above, in some described embodiments, the video transcript segmentation system 102 generates a segmented video transcript. In particular, the video transcript segmentation system 102 can process extracted audio features from a digital video and extracted video features from the digital video to determine a set of break points which, in turn, can be utilized to generate the segmented video transcript. FIG. 5 illustrates an example diagram for utilizing extracted audio features and extracted video features to generate a segmented video transcript in accordance with one or more embodiments.

As illustrated in FIG. 5, the video transcript segmentation system 102 utilizes a break point prediction model 504 to generate predicted breaks in a digital video according to guidance parameters 502. Specifically, in some cases, the break point prediction model 504 is a heuristic model that generates potential break points. To elaborate, the break point prediction model 504 is made up of computer code that is executable to weigh extracted audio features 506 and extracted video features 508 and to combine weighted feature-specific scores into confidence scores for break point locations. For instance, the break point prediction model 504 applies different weights to different audio features and video features, depending on their respective impact or indicative-ness where break points occur in a digital video (e.g., where a feature indicating a transition to a new camera is weighted more heavily than a feature indicating a speech stop).

In some embodiments, the break point prediction model 504 is a large language model that can process a specially designed prompt with guidance parameters 502 to generate one or more potential break points. For instance, such guidance parameters 502 can include a text description or an indication or request for: timestamp formatting for a segmented video transcript 522, a stated role for the break point prediction model 504, a specified number of transcript sections (e.g., paragraphs, chapters, or segments) for the segmented video transcript 522, and/or a threshold length for one or more sections (e.g., paragraphs, chapters, or segments) in the segmented video transcript 522. In some embodiments, the indicated or requested threshold length for one or more sections can include a maximum character number and/or a maximum word number. Additionally, the guidance parameters 502 can, in some instances, further include an indication or request for a specific format for the segmented video transcript 522 and/or inserting headers and/or titles in the segmented video transcript 522. The guidance parameters 502 can also include examples of recommended transcript formatting.

As mentioned, the video transcript segmentation system 102 utilizes the break point prediction model 504 to generate confidence scores. In particular, the break point prediction model 504 (e.g., a heuristic model or a large language model) processes extracted audio features 506 and extracted video features 508 (and, in some cases, in combination with guidance parameters 502) to generate a first confidence score 510 and a second confidence score 512. To illustrate, the break point prediction model 504 generates the first confidence score 510 from the extracted audio features 506 and the second confidence score 512 from the extracted video features 508. In some embodiments, the break point prediction model 504 can receive instructions to assign a particular weight to a specific audio feature or to a specific video feature based on, for example, the significance (or importance) of the feature in indicating a break point.

In some embodiments, the break point prediction model 504 can generate confidence scores by utilizing the break point prediction model 504 in the form of a trained machine learning model to predict timestamp locations in the digital video from the extracted audio features 506 and the extracted video features 508. As an example, the break point prediction model 504 can utilize the trained machine learning model to predict that one or more timestamp locations in the digital video are points where edits are likely to be made based on supervised training data indicating sample audio/video features and corresponding timestamps for edits. In some embodiments, the break point prediction model 504 can, in some instances, determine timestamp data for the first confidence score 510 and the second confidence score 512. For example, the break point prediction model 504 can generate predicted timestamp locations where edits are likely to be made and/or timestamps corresponding to determined confidence scores.

As further illustrated in FIG. 5, upon generating the first confidence score 510 and the second confidence score 512, the break point prediction model 504 can perform a combination of confidence scores 514 to generate a break point score 516. Specifically, in some instances, the break point prediction model 504 combines the first confidence score 510 with the second confidence score 512 to generate the break point score 516. In one or more embodiments, the break point prediction model 504 performs the combination of confidence scores 514 to generate the break point score 516 by determining that the first confidence score 510 and the second confidence score 512 are combinable. Indeed, the break point prediction model 504 combines the audio-based confidence scores and the video-based confidence score based on a relationship between the confidence scores (e.g., a timespan between timestamps corresponding to the confidence scores).

As shown in FIG. 5, the break point prediction model 504 utilizes the break point score 516 to generate a potential break point 518. In particular, the break point prediction model 504 generate the potential break point 518 by determining a timestamp corresponding to the break point score 516. Thus, the break point prediction model 504 generates a potential break point for every timestamp where a break point score is generated.

As also shown in FIG. 5, the break point prediction model 504 determines a set of break points 520 based on one or more potential break points. For instance, the break point prediction model 504 can filter potential break points to generate the set of break points 520. To elaborate, the break point prediction model 504 generates the set of break points 520 by comparing one or more break point scores corresponding to one or more particular potential break points with a given threshold for designating a break point at a particular timestamp in the digital video. For instance, the break point prediction model 504 can compare the break point score 516 with the given threshold, and if the break point score 516 significantly drops below the given threshold the break point prediction model 504 can determine that a notable change in a pattern has occurred. Based on the notable change in the pattern, the break point prediction model 504 can, in some embodiments, determine that the potential break point 518 be included in the set of break points 520.

In one or more embodiments, the break point prediction model 504 determines the set of break points 520 by implementing a global optimization model for selecting a number of potential break points that satisfy at least a threshold break point score (or confidence score). As an example, the break point prediction model 504 can implement a global optimization model to select five (5) to eight (8) potential break points and determine that the sum of the break point scores for each of the five (5) to eight (8) potential break points will be as high as possible (i.e., will satisfy at least a threshold break point score). In other instances, the break point prediction model 504 determines the set of break points 520 by implementing a greedy selection to, for example, exclude (or remove) potential break points which have timestamps that are too close together (e.g., based on a threshold) and select a potential break point that has a highest scoring break point score.

As further shown in FIG. 5, the break point prediction model 504 utilizes the set of break points 520 to generate a segmented video transcript 522. In particular, the break point prediction model 504 indicates break points contained within the set of break points 520 by utilizing markers at particular timestamps in the digital video. For example, the markers utilized by the break point predication model 504 can include: i) metadata tags, such as an identifier of a type of content (e.g., “Topic 1”) or as an annotation to describe the nature of the break point (e.g., “Scene Transition” or “Speaker Change”); ii) inserting the words “BREAK POINT” or some other indicative term or phrase; iii) added whitespace; iv) indentation and/or bullets; v) visual markers (e.g., color highlights); and/or vi) generating and inserting headers and/or titles. In one or more embodiments, the break point prediction model 504 generates segments (e.g., paragraphs, chapters, or sections) in the segmented video transcript 522 according to the markers at particular timestamps in the digital video that correspond to respective break points contained within the set of break points 520. To further illustrate, the break point prediction model 504 can, as shown, generate segments in the segmented video transcript 522 according to title markers (e.g., “Title 1”), header markers (e.g., “Header 1” and “Header 2”), topic markers (e.g., “Topic 1,” “Topic 2,” “Topic 3,” “Topic 4,” and “Topic 5”), or speaker markers (e.g., “Speaker 1,” “Speaker 2,” and “Speaker 3”).

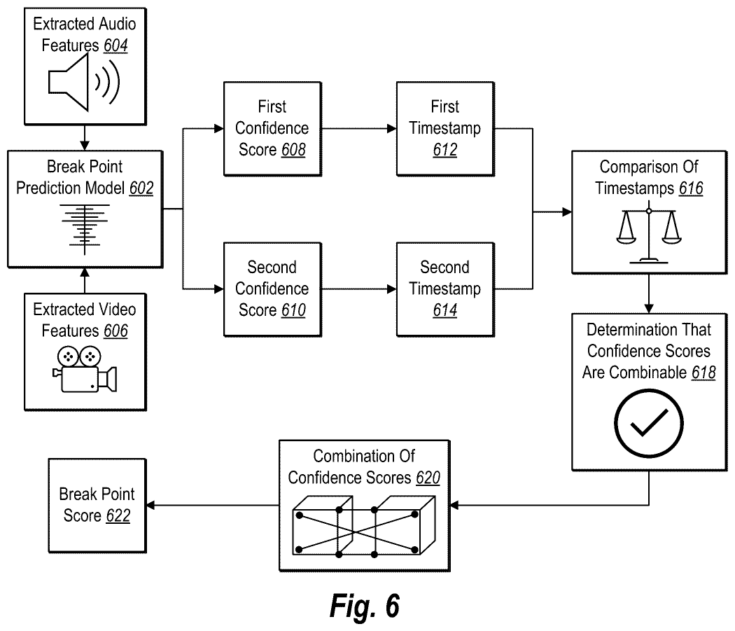

As indicated above, in certain described embodiments, the video transcript segmentation system 102 generates a potential break point. Specifically, the video transcript segmentation system 102 can generate the potential break point by combining a first confidence score with a second confidence score to generate a break point score indicating the potential break point. FIG. 6 illustrates an example diagram for generating a break point score in accordance with one or more embodiments.

As illustrated in FIG. 6, the video transcript segmentation system 102 utilizes a break point prediction model 602 to generate a first confidence score 608 and a second confidence score 610. In particular, the break point prediction model 602 processes extracted audio features 604 to generate a first confidence score 608 (for an audio-based potential break point). For instance, the first confidence score 608 can be a numerical value (e.g., between 0 and 1) that represents the probability (or likelihood) that, based on the extracted audio features 604, a break point exists at a particular timestamp. Similarly, the break point prediction model 602 processes extracted video features 606 to generate a second confidence score 610 (for a video-based potential break point). For example, the second confidence score 610 can be a numerical value (e.g., between 0 and 1) that represents the probability (or likelihood) that, based on the extracted video features 606, a break point exists at a particular timestamp.

As also illustrated in FIG. 6, the break point prediction model 602 determines a first timestamp 612 and a second timestamp 614. Specifically, the break point prediction model 602 determines the first timestamp 612 corresponding to the first confidence score 608 (as generated from extracted audio features 604) by determining and denoting the point in the digital video where a particular audio feature was identified and extracted. Similarly, the break point prediction model 602 determines the second timestamp 614 corresponding to the second confidence score 610 (as generated from extracted video features 606) by determining and denoting the point in the digital video where a particular video feature was identified and extracted. In the same or other embodiments, the break point prediction model 602 determines the first timestamp 612 and the second timestamp 614 by analyzing the extracted audio features 604 and the extracted video features 606, respectively, and denoting where in the digital video a particular feature occurs.

As further illustrated in FIG. 6, in some embodiments, the break point prediction model 602 determines that confidence scores are combinable 618 by making a comparison of timestamps 616. In particular, the break point prediction model compares the first timestamp 612 with the second timestamp 614 to determine whether the timestamps are within a given threshold (e.g., a specified threshold time difference) in the digital video. The break point prediction model 602 determines this, for example, to determine whether audio features and video features extracted at respective timestamps should reflect the same instance, or break point, within the video. If the first timestamp 612 and the second timestamp 614 are close enough together, the break point prediction model 602 determines that the timestamps, and therefore the confidence scores, are combinable into the break point score 622. As an example, the break point prediction model 602 can determine that the first timestamp 612 and the second timestamp 614 fall within a two (2) second time range window in the digital video to combine them.

Upon making the determination that confidence scores are combinable 618, the break point prediction model 602 performs a combination of confidence scores 620 to generate the break point score 622. Specifically, the break point prediction model 602 performs the combination of confidence scores 620 by aligning the first confidence score 608 (for audio-based potential break points) with the second confidence score 610 (for video-based potential break points) and combining the first and second confidence scores together. The break point prediction model 602 can combine the first confidence score 608 and the second confidence score 610 by utilizing one or more methods, including: a simple average (or arithmetic mean), a weighted average, a geometric mean, a minimum or maximum selection (e.g., select the lowest or highest score, respectively), and/or utilizing probabilistic models (e.g., logistic regression models or Bayesian models). In consequence of the combination of confidence scores 620, the break point prediction model 602 generates the break point score 622 in accordance with one or more embodiments.

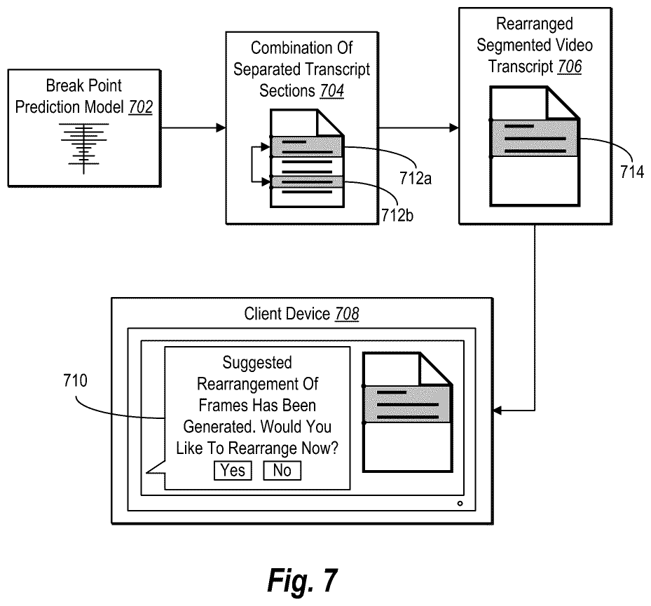

As mentioned above, in specific described embodiments, the video transcript segmentation system 102 generates a rearranged segmented video transcript. Specifically, the video transcript segmentation system 102 can combine separated transcript sections together into a single location in the segmented video transcript on a topic-wise basis. FIG. 7 illustrates an example diagram for combining separated transcript sections in accordance with one or more embodiments.

As illustrated in FIG. 7, the video transcript segmentation system 102 utilizes a break point prediction model 702 to determine topic matter of a segmented video transcript. In particular, the video transcript segmentation system 102 can utilize a break point prediction model 702 to generate a segmented video transcript (or a video transcript). In some instances, the break point prediction model 702 analyzes sections in the segmented video transcript to perform the combination of separated transcript sections 704. For instance, the break point prediction model 702 can implement algorithms (e.g., clustering algorithms) to analyze and group, based on semantic similarity, the specific sections of the segmented video transcript into topic-specific clusters. To elaborate, the break point prediction model 702 can, in some instances, utilize a clustering model to extract section embeddings from sections of the segmented video transcript and cluster the embeddings in an embedding space. In one or more embodiments, the clustering model can generate the topic-specific clusters by, for example, analyzing clusters of embeddings to identify keywords or phrases that the break point prediction model 702 determines to be representative of one or more topics. Based on the topic-specific clusters, the clustering model can rearrange sections in the segmented video transcript according to topic. In the same or other embodiments, the break point prediction model 702 can perform the combination of separated transcript sections 704 by determining distances between section embeddings in the embedding space to determine relationships between the sections. Based on the determined relationships between the sections, the break point prediction model 702 can, in some cases, rearrange the segmented video transcript to group sections together whose embedding are within a threshold distance from one another.

Based on the foregoing, the break point prediction model 702 performs the combination of separated transcript sections 704 to generate a rearranged segmented video transcript 706. In one or more embodiments, the break point prediction model 702 rearranges one or more of the sections of the segmented video transcript to combine sections that relate to a similar or common topic into a single location. The break point prediction model 702 rearranges the one or more sections even if, for example, the sections are separated from one another by other segmented video transcript content. For instance, as shown, the break point prediction model 702 can combine section 712a of a segmented video transcript with section 712b of the segmented video transcript to generate section 714 of the rearranged segmented video transcript 706. Accordingly, the break point prediction model 702 performs the combination of separated transcript sections 704 to thereby, in some instances, generate the rearranged segmented video transcript 706.

As further illustrated in FIG. 7, the video transcript segmentation system 102 generates, for display on a client device 708, a video break notification 710 to suggest rearranging frames of a digital video. To elaborate, the video transcript segmentation system 102 processes the rearranged segmented video transcript 706 to generate the video break notification 710 to suggest rearranging the frames of the digital video to coincide with one or more rearranged transcript sections. In some cases, the video transcript segmentation system 102 displays the video break notification 710 on the graphical user interface of the client device 708.

Additionally, in one or more embodiments, the video transcript segmentation system 102 generates, for display on the graphical user interface of the client device 708, the video break notification 710 with one or more selectable elements that provide an option for whether or not to rearrange frames of the digital video. For example, as shown, the video break notification 710 has a selectable element “Yes” to implement a suggested rearrangement of frames, and selectable element “No” to decline implementing the suggested rearrangement of frames. In one or more embodiments, the video transcript segmentation system 102 permits selecting which specific suggestion(s) for rearranging frames will be implemented into the digital video and which specific suggestion(s) for rearranging frames will not be implemented into the digital video. In the same or other embodiments, the video transcript segmentation system 102 can automatically insert suggestions for rearranging frames into the digital video without requiring a selection of a selectable elements.

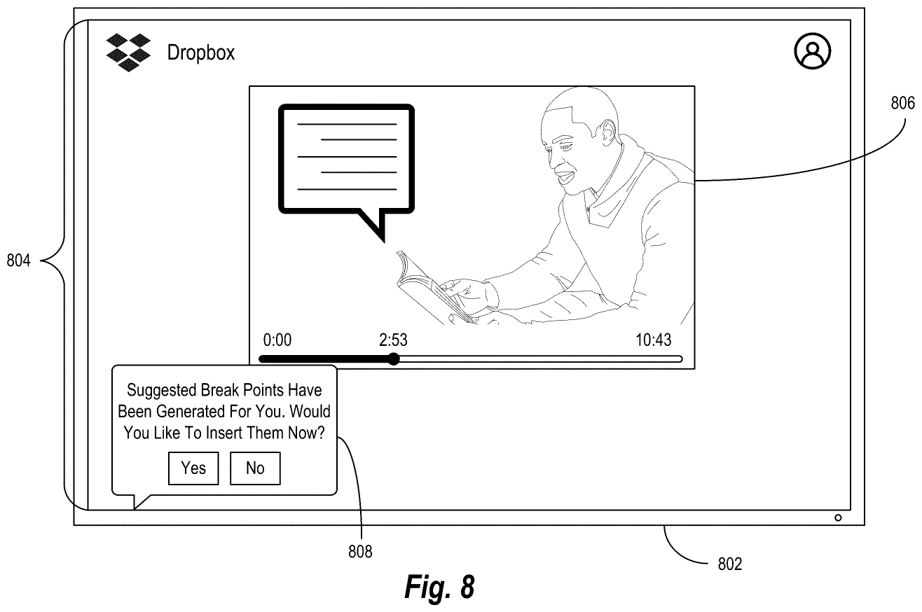

As previously mentioned, in certain embodiments, the video transcript segmentation system 102 generates and provides a suggestion to insert segments into a digital video. For example, the video transcript segmentation system 102 generates and provides a video break notification suggesting the insertion of the segments into the digital video. FIG. 8 illustrates an example graphical user interface for providing the video break notification in accordance with one or more embodiments.

As illustrated in FIG. 8, the video transcript segmentation system 102 generates and provides a graphical user interface 804 for display on a client device 802. In particular, the video transcript segmentation system 102 displays a digital video 806 on the graphical user interface 804 of the client device 802. As shown, for example, the digital video 806 includes ten minutes and forty-three seconds of digital content, including audio content and video content. In some embodiments, the audio content and the video content can be separable data streams.

As further illustrated in FIG. 8, the video transcript segmentation system 102 generates a video break notification 808 for display within the graphical user interface 804. For example, upon detecting that the client device 802 is displaying the digital video 806, and upon generating a segmented video transcript containing segments (e.g., paragraphs, sections, or chapters), the video transcript segmentation system 102 generates and provides the video break notification 808. Specifically, the video transcript segmentation system 102 generates the video break notification 808 to include a suggestion to insert the segments into the digital video 806 at timestamps aligning with potential break points generated for the segmented video transcript.

In some embodiments, the video transcript segmentation system 102 also generates the video break notification 808 with one or more selectable elements to, for example, accept or decline inserting the segments. Indeed, upon selection of a “Yes” selectable element option, the video transcript segmentation system 102 inserts the suggested segments into the digital video 806. Conversely, upon selection of a “No” selectable element option, the video transcript segmentation system 102 declines inserting the suggested segments into the digital video 806. In one or more embodiments, the video transcript segmentation system 102 permits selecting which specific segments will be inserted into the digital video 806 and which specific segments will not be inserted into the digital video 806. In the same or other embodiments, the video transcript segmentation system 102 can automatically insert the suggested segments into the digital video 806 without requiring a selection of a selectable elements.

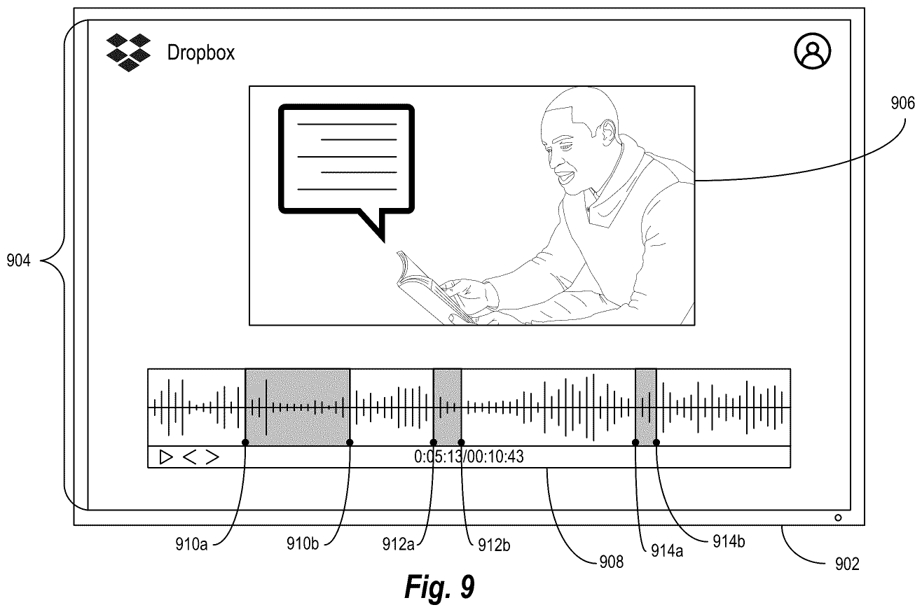

As stated above, in some embodiments, the video transcript segmentation system 102 can insert segments into a digital video. Specifically, upon the selection of a particular selectable element on the graphical user interface of a client device (e.g., “Yes”), the video transcript segmentation system 102 inserts the segments into the video timeline of the digital video. FIG. 9 illustrates an example graphical user interface that is displaying inserted segments in accordance with one or more embodiments.

As illustrated in FIG. 9, the video transcript segmentation system 102 generates and provides a graphical user interface 904 for display on a client device 902. In particular, the video transcript segmentation system 102 displays a digital video 906 on the graphical user interface 904 of the client device 902. As shown, for example, the digital video 906 includes ten minutes and forty-three seconds of digital content, including audio content (e.g., as represented by the text box) and video content (e.g., as represented by the man reading). In some embodiments, the audio content and the video content can be separable data streams.

As further illustrated in FIG. 9, the video transcript segmentation system 102 can insert suggested segments (e.g., paragraphs, sections, or chapters) into video timeline 908 of the digital video 906. For example, upon a selection of a particular selectable element (e.g., “Yes”) included in a video break notification, the video transcript segmentation system 102 inserts the suggested segments into the video timeline 908 of the digital video 906. In the same or other embodiments, the video transcript segmentation system 102 can automatically insert the suggested segments into the video timeline 908 of the digital video 906 without requiring the selection of a selectable element. As shown, the video transcript segmentation system 102 can, for example, insert break points 910a, 910b, 912a, 912b, 914a, and 914b from a suggested set of break points into the video timeline 908. In some cases, inserted break points can mark particular segments of the video timeline 908, including any rearranged segments. For instance, as shown, the portion of the video timeline 908 spanning from break point 910a to break point 910b represents a first segment, the portion of the video timeline 908 spanning from break point 912a to break point 912b represents a second segment, and the portion of the video timeline 908 spanning from break point 914a to break point 914b represents a third segment.

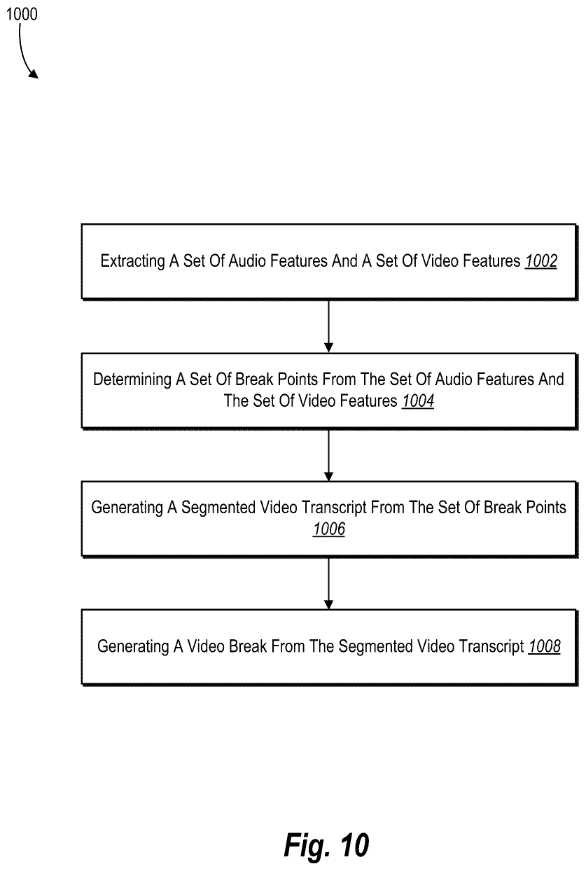

FIGS. 1-9, the corresponding text, and the examples provide a number of different systems and methods for generating and visualizing a segmented video transcript. In addition to the foregoing, implementations can also be described in terms of flowcharts comprising acts steps in a method for accomplishing a particular result. For example, FIG. 10 illustrates an example series of acts generating and visualizing a segmented video transcript.

While FIG. 10 illustrates acts according to certain implementations, alternative implementations may omit, add to, reorder, and/or modify any of the acts shown in FIG. 10. The acts of FIG. 10 can be performed as part of a method. Alternatively, a non-transitory computer readable medium can comprise instructions that, when executed by one or more processors, cause a computing device to perform the acts of FIG. 10. In still further implementations, a system can perform the acts of FIG. 10.

As illustrated in FIG. 10, the series of acts 1000 may include an act 1002 of extracting a set of audio features and a set of video features. In particular, the act 1002 involves extracting, from a digital video, a set of audio features defining changes in audio content throughout the digital video and a set of video features defining changes in video content throughout the digital video. The series of acts 1000 can also include an act 1004 of determining a set of break points from the set of audio features and the set of video features. In particular, the act 1004 can involve determining a set of break points for segmenting the digital video into sections based on the set of audio features and the set of video features. In addition, the series of acts 1000 can include an act 1006 of generating a segmented video transcript from the set of break points. In particular, the act 1006 can involve generating, for the digital video, a segmented video transcript comprising separated transcript sections according to the set of break points. Further, the series of acts 1000 can include an act 1008 of generating a video break from the segmented video transcript. In some cases, the series of acts 1000 can include an act of providing, for display on a client device, a video break notification suggesting a timestamp of the digital video for inserting a break based on the segmented video transcript.

In some embodiments, the series of acts 1000 includes an act of extracting the set of audio features by extracting features indicating one or more of a topic change in the audio content, a sentence break in the audio content, a speech start in the audio content, or a speech stop in the audio content. The series of acts 1000 can also include an act of generating the segmented video transcript by using a large language model to generate predicted breaks in the digital video according to guidance parameters including one or more of timestamp formatting for the segmented video transcript, a stated role for the large language model, an indicated number of segments in the segmented video transcript, or a maximum segment length for segments in the segmented video transcript.

In some embodiments, the series of acts 1000 includes an act of extracting the set of video features by extracting features indicating one or more of: a visual makeup of a frame in the video content; or a threshold change in composition of the video content between frames of the digital video. In the same or other embodiments, the series of acts 1000 includes an act of determining the set of break points by utilizing a heuristic model to generate confidence scores for potential break points with the digital video by processing the set of audio features and the set of video features.

In one or more embodiments, the series of acts 1000 includes an act of utilizing the heuristic model to generate the confidence scores for the potential break points by: generating, for a potential break point, a first confidence score from the set of audio features and a second confidence score from the set of video features; and combining the first confidence score and the second confidence score into a break point score for the potential break point. The series of acts 1000 can also include an act of combining the first confidence score and the second confidence score by: comparing a first timestamp for an audio-based potential break point determined from the set of audio features with a second timestamp for a video-based potential break point determined from the set of video features; and determining, based on comparing the first timestamp and the second timestamp, that the first timestamp and the second timestamp are combinable into a single break point for the digital video.

Additionally, the series of acts 1000 can include an act of extracting the set of video features by extracting features indicating a visual makeup of a frame in the video content based on performing a color analysis of pixels in the frame. The series of acts 1000 can also include an act of extracting the set of video features by: extracting a first video frame embedding that encodes video content of a first frame within the digital video; extracting a second video frame embedding that encodes video content of a second frame within the digital video; and comparing the first video frame embedding and the second video frame embedding.

In some embodiments, the series of acts 1000 includes an act of determining the set of break points by: determining, from the set of audio features, audio timestamps within the digital video for audio-based potential break points; determining, from the set of video features, video timestamps within the digital video for video-based potential break points; and aligning the audio-based potential break points with the video-based potential break points based on comparing the audio timestamps and the video timestamps. The series of acts 1000 can also include an act of generating the segmented video transcript by utilizing a heuristic model to generate transcript sections having at least a threshold length.

In certain embodiments, the series of acts 1000 includes an act of generating the segmented video transcript by utilizing a heuristic model to generate a specified number of transcript sections. Additionally, the series of acts 1000 can include an act of generating the set of break points by implementing a global optimization model for selecting a number of break points that satisfy at least a threshold confidence score.

In one or more implementation, the series of acts 1000 includes an act of extracting the set of video features by extracting features indicating a change in an object depicted within the digital video. Further, the series of acts 1000 can include an act of extracting the features indicating the change in the object by extracting features indicating one or more of presence of a new object within a frame of the digital video or absence of a previously depicted object within the digital video.

In some embodiments, the series of acts 1000 includes an act of combining one or more separated transcript sections within the segmented video transcript that relate to a common topic; and generating the video break notification to suggest rearranging frames of the digital video to coincide with the one or more separated transcript sections combined based on the common topic. The series of acts 1000 can include an act of generating the set of break points by using a break point prediction model to predict timestamp locations for the digital video based on the set of audio features and the set of video features. The series of acts 1000 can further include an act of extracting the set of video features by utilizing a filtering technique to extract features indicating a transition in the video content.

The components of the video transcript segmentation system 102 can include software, hardware, or both. For example, the components of the video transcript segmentation system 102 can include one or more instructions stored on a computer-readable storage medium and executable by processors of one or more computing devices. When executed by one or more processors, the computer-executable instructions of the video transcript segmentation system 102 can cause a computing device to perform the methods described herein. Alternatively, the components of the video transcript segmentation system 102 can comprise hardware, such as a special purpose processing device to perform a certain function or group of functions. Additionally or alternatively, the components of the video transcript segmentation system 102 can include a combination of computer-executable instructions and hardware.

Furthermore, the components of the video transcript segmentation system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the video transcript segmentation system 102 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of exemplary computing device 1100 (e.g., the server(s) 104 and/or the client device 108) that may be configured to perform one or more of the processes described above. One will appreciate that server(s) 104 and/or the client device 108 may comprise one or more computing devices such as computing device 1100. As shown by FIG. 11, computing device 1100 can comprise processor 1102, memory 1104, storage device 1106, I/O interface 1108, and communication interface 1110, which may be communicatively coupled by way of communication infrastructure 1112. While an exemplary computing device 1100 is shown in FIG. 11, the components illustrated in FIG. 11 are not intended to be limiting. Additional or alternative components may be used in other implementations. Furthermore, in certain implementations, computing device 1100 can include fewer components than those shown in FIG. 11. Components of computing device 1100 shown in FIG. 11 will now be described in additional detail.

In particular implementations, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage device 1106 and decode and execute them. In particular implementations, processor 1102 may include one or more internal caches for data, instructions, or addresses. As an example and not by way of limitation, processor 1102 may include one or more instruction caches, one or more data caches, and one or more translation lookaside buffers (TLBs). Instructions in the instruction caches may be copies of instructions in memory 1104 or storage device 1106.

Memory 1104 may be used for storing data, metadata, and programs for execution by the processor(s). Memory 1104 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1104 may be internal or distributed memory.

Storage device 1106 includes storage for storing data or instructions. As an example and not by way of limitation, storage device 1106 can comprise a non-transitory storage medium described above. Storage device 1106 may include a hard disk drive (HDD), a floppy disk drive, flash memory, an optical disc, a magneto-optical disc, magnetic tape, or a Universal Serial Bus (USB) drive or a combination of two or more of these. Storage device 1106 may include removable or non-removable (or fixed) media, where appropriate. Storage device 1106 may be internal or external to computing device 1100. In particular implementations, storage device 1106 is non-volatile, solid-state memory. In other implementations, Storage device 1106 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1108 allows a user to provide input to, receive output from, and otherwise transfer data to and receive data from computing device 1100. I/O interface 1108 may include a mouse, a keypad or a keyboard, a touch screen, a camera, an optical scanner, network interface, modem, other known I/O devices or a combination of such I/O interfaces. I/O interface 1108 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1108 is configured to provide graphical data to a display for presentation to a user. The graphical data may be representative of one or more graphical user interfaces and/or any other graphical content as may serve a particular implementation.

Communication interface 1110 can include hardware, software, or both. In any event, communication interface 1110 can provide one or more interfaces for communication (such as, for example, packet-based communication) between computing device 1100 and one or more other computing devices or networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1110 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1110 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1110 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1112 may include hardware, software, or both that couples components of computing device 1100 to each other. As an example and not by way of limitation, communication infrastructure 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 12 is a schematic diagram illustrating environment 1200 within which one or more implementations of the video transcript segmentation system 102 can be implemented. For example, the video transcript segmentation system 102 may be part of a content management system 1202 (e.g., the content management system 106). Content management system 1202 may generate, store, manage, receive, and send digital content (such as digital content items). For example, content management system 1202 may send and receive digital content to and from client devices 1206 by way of network 1204. In particular, content management system 1202 can store and manage a collection of digital content. Content management system 1202 can manage the sharing of digital content between computing devices associated with a plurality of users. For instance, content management system 1202 can facilitate a user sharing a digital content with another user of content management system 1202.

In particular, content management system 1202 can manage synchronizing digital content across multiple client devices 1206 associated with one or more users. For example, a user may edit digital content using client device 1206. The content management system 1202 can cause client device 1206 to send the edited digital content to content management system 1202. Content management system 1202 then synchronizes the edited digital content on one or more additional computing devices.

In addition to synchronizing digital content across multiple devices, one or more implementations of content management system 1202 can provide an efficient storage option for users that have large collections of digital content. For example, content management system 1202 can store a collection of digital content on content management system 1202, while the client device 1206 only stores reduced-sized versions of the digital content. A user can navigate and browse the reduced-sized versions (e.g., a thumbnail of a digital image) of the digital content on client device 1206. In particular, one way in which a user can experience digital content is to browse the reduced-sized versions of the digital content on client device 1206.

Another way in which a user can experience digital content is to select a reduced-size version of digital content to request the full- or high-resolution version of digital content from content management system 1202. In particular, upon a user selecting a reduced-sized version of digital content, client device 1206 sends a request to content management system 1202 requesting the digital content associated with the reduced-sized version of the digital content. Content management system 1202 can respond to the request by sending the digital content to client device 1206. Client device 1206, upon receiving the digital content, can then present the digital content to the user. In this way, a user can have access to large collections of digital content while minimizing the amount of resources used on client device 1206.

Client device 1206 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1206 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1204.

Network 1204 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1206 may access content management system 1202.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
extracting, from a digital video, a set of audio features defining changes in audio content throughout the digital video and a set of video features defining changes in video content throughout the digital video;
determining a set of break points for segmenting the digital video into sections based on the set of audio features and the set of video features;
generating, for the digital video, a segmented video transcript comprising separated transcript sections according to the set of break points; and
generating a video break from the segmented video transcript.

2. The computer-implemented method of claim 1, wherein extracting the set of audio features comprises extracting features indicating one or more of a topic change in the audio content, a sentence break in the audio content, a speech start in the audio content, or a speech stop in the audio content.

3. The computer-implemented method of claim 1, wherein generating the segmented video transcript comprises using a large language model to generate predicted breaks in the digital video according to guidance parameters including one or more of timestamp formatting for the segmented video transcript, a stated role for the large language model, an indicated number of segments in the segmented video transcript, or a maximum segment length for segments in the segmented video transcript.

4. The computer-implemented method of claim 1, wherein extracting the set of video features comprises extracting features indicating one or more of:
a visual makeup of a frame in the video content; or
a threshold change in composition of the video content between frames of the digital video.

5. The computer-implemented method of claim 1, wherein determining the set of break points comprises utilizing a heuristic model to generate confidence scores for potential break points with the digital video by processing the set of audio features and the set of video features.

6. The computer-implemented method of claim 5, wherein utilizing the heuristic model to generate the confidence scores for the potential break points comprises:
generating, for a potential break point, a first confidence score from the set of audio features and a second confidence score from the set of video features; and
combining the first confidence score and the second confidence score into a break point score for the potential break point.

7. The computer-implemented method of claim 6, wherein combining the first confidence score and the second confidence score comprises:
comparing a first timestamp for an audio-based potential break point determined from the set of audio features with a second timestamp for a video-based potential break point determined from the set of video features; and
determining, based on comparing the first timestamp and the second timestamp, that the first timestamp and the second timestamp are combinable into a single break point for the digital video.

8. A system comprising:
at least one processor; and
at least one non-transitory computer-readable storage medium storing instructions that, when executed by the at least one processor, cause the system to:
extract, from a digital video, a set of audio features defining changes in audio content throughout the digital video and a set of video features defining changes in video content throughout the digital video;
determine, utilizing a break point prediction model to process the set of audio features and the set of video features, a set of break points for segmenting the digital video into sections;
generate a segmented video transcript comprising separated transcript sections according to the set of break points; and
provide, for display on a client device, a video break notification suggesting a timestamp of the digital video for inserting a break based on the segmented video transcript.

9. The system of claim 8, further comprising instructions that, when executed by the at least one processor, cause the system to extract the set of video features by extracting features indicating a visual makeup of a frame in the video content based on performing a color analysis of pixels in the frame.

10. The system of claim 8, further comprising instructions that, when executed by the at least one processor, cause the system to extract the set of video features by:
extracting a first video frame embedding that encodes video content of a first frame within the digital video;
extracting a second video frame embedding that encodes video content of a second frame within the digital video; and
comparing the first video frame embedding and the second video frame embedding.

11. The system of claim 8, further comprising instructions that, when executed by the at least one processor, cause the system to determine the set of break points by:
determining, from the set of audio features, audio timestamps within the digital video for audio-based potential break points;
determining, from the set of video features, video timestamps within the digital video for video-based potential break points; and
aligning the audio-based potential break points with the video-based potential break points based on comparing the audio timestamps and the video timestamps.

12. The system of claim 8, further comprising instructions that, when executed by the at least one processor, cause the system to generate the segmented video transcript by utilizing a heuristic model to generate transcript sections having at least a threshold length.

13. The system of claim 8, further comprising instructions that, when executed by the at least one processor, cause the system to generate the segmented video transcript by utilizing a heuristic model to generate a specified number of transcript sections.

14. The system of claim 8, further comprising instructions that, when executed by the at least one processor, cause the system to generate the set of break points by implementing a global optimization model for selecting a number of break points that satisfy at least a threshold confidence score.

15. A non-transitory computer-readable medium storing instructions that, when executed by at least one processor, cause a computer system to:
extract, from a digital video, a set of audio features defining changes in audio content throughout the digital video and a set of video features defining changes in video content throughout the digital video;
determine a set of break points for dividing the digital video into sections based on the set of audio features and the set of video features;
generate, for the digital video, a segmented video transcript by separating transcript sections at timestamps indicated by the set of break points; and
generate a video break from the segmented video transcript.

16. The non-transitory computer-readable medium of claim 15, further comprising instructions that, when executed by the at least one processor, cause the computer system to extract the set of video features by extracting features indicating a change in an object depicted within the digital video.

17. The non-transitory computer-readable medium of claim 16, wherein extracting the features indicating the change in the object comprises extracting features indicating one or more of presence of a new object within a frame of the digital video or absence of a previously depicted object within the digital video.

18. The non-transitory computer-readable medium of claim 15, further comprising instructions that, when executed by the at least one processor, cause the computer system to:
combine one or more separated transcript sections within the segmented video transcript that relate to a common topic; and
generate, for display on a client device, a video break notification to suggest rearranging frames of the digital video to coincide with the one or more separated transcript sections combined based on the common topic.

19. The non-transitory computer-readable medium of claim 15, further comprising instructions that, when executed by the at least one processor, cause the computer system to generate the set of break points by using a break point prediction model to predict timestamp locations for the digital video based on the set of audio features and the set of video features.

20. The non-transitory computer-readable medium of claim 15, further comprising instructions that, when executed by the at least one processor, cause the computer system to extract the set of video features by utilizing a filtering technique to extract features indicating a transition in the video content.
